(19) United States
(12) Patent Application Publication
(10) Pub. No.: US 2023/0159731 A1
(43) Pub. Date: May 25, 2023

(54) HEAT-TREATED BIOMASS, METHOD OF MAKING AND USING OF THE SAME

(71) Applicant: Agri-Tech Producers, LLC, Columbia, SC (US)

(72) Inventor: Joseph J. JAMES, Columbia, SC (US)

(73) Assignee: Agri-Tech Producers, LLC, Columbia, SC (US)

(21) Appl. No.: 17/992,594

(22) Filed: Nov. 22, 2022

Related U.S. Application Data
(60) Provisional application No. 63/282,039, filed on Nov. 22, 2021.

(51) Int. Cl. C08L 23/06; C08L 23/12

(52) U.S. Cl. CPC C08L 23/06; C08L 23/12

(57) ABSTRACT

Agricultural feed stock is heat treated to form a heat-treated biomass for industrial use as an alternative replacement of conventional additives and fillers. The agricultural feedstock is selected from the group consisting of biomass sorghum, wood, nut sells, soybean hulls, and a combination thereof. The heat-treated biomass is made into fine particles and used as fillers or additives to be combined with plastic to create a polymeric composite with high heat deflection, good mechanical, and superior barrier properties. The polymeric composite provides an alternative to conventional polymeric composites which contain virgin plastic materials and industrial additives, fillers, and colorants. Incorporation of heat-treated biomass into recycled or reclaimed plastic provides improvement to diminished properties of these materials. The polymeric composites described herein can be incorporated into a variety of end products such as cutlery, containers for packaging, hot server items, hard plastic casings, 3-D printed items, and other items.

### CROSS-REFERENCE TO RELATED APPLICATIONS

This application claims benefit of U.S. Provisional Patent Application Ser. No. 63/282,039, filed Nov. 22, 2021, which is herein incorporated by reference.

### FIELD OF THE PRESENT DISCLOSURE

The present disclosure is directed to heat treated biomass and methods of making the same. The present disclose is additionally directed to methods to use the heat-treated biomass, for example as additives or fillers in polymeric composite(s).

### BACKGROUND

Industrial additives and fillers such as glass fibers, calcium carbonate, elastomers, and natural rubber have been used in many industrial applications. For example, industrial additives and fillers have been used in polymers to make polymeric composite materials. It can also displace the cost of adding virgin material to recycled plastics. Glass fiber-filled polymeric composites are known to have high stiffness, good weight-to-strength ratio, and high impact strength which make them ideal for interior as well as exterior automotive parts. Talc powder, a commonly used industrial filler, can also increase stiffness and mechanical strength of polymers such as reclaimed plastics. Other additives such as carbon black, talc, and titanium dioxide are used in making polymeric composite materials as colorants and offer very little improvement to the mechanical properties of these materials.

Due to growing public concern for the reduction of greenhouse gases, industry has focused on the utilization of biomass such as forest trimmings, farming residues and agricultural wastes, animal byproducts, food waste, etc. as additives for polymers such as recycled plastics. Biomass reinforced plastic composites have been developed for many applications mainly because the biomass used in making the plastic composites is derived from sustainable, natural resources and therefore can reduce greenhouse gas emissions considerably. Moreover, handling of biomass yields less health and safety hazards and produces much less wear on processing equipment, unlike, for example, glass fiber-filled recycled plastic composites. One disadvantage of the use of biomass as additives for polymeric composites is the hydrophilic nature of the materials. Biomass mainly contains hemicellulose, amorphous and crystalline cellulose, lignin, and, to some extent, volatile organic acids, and oils. The hydrophilic nature of the hemicellulose and amorphous cellulose components makes the biomass incompatible with hydrophobic polymers such as recycled plastics, resulting in poor interfacial adhesion between the natural fibers and the polymer matrix. Another disadvantage is the poor thermal properties of the biomass which can degrade during melt-blending with polymers such as recycled plastics. Without pretreatment, the processing temperatures of polymers such as recycled plastics can lead to degradation of the main components of the biomass, which negatively affects the structural integrity of the resulting polymeric composite material. Finally, to some extent, elimination of volatile materials, commonly known as off-gassing may also occur which can be problematic during production of the polymeric composite materials.

Beyond niche markets such as recycled plastics, biomass filler has broader potential market appeal in durable goods such as automotive parts and household wares. However, it is difficult for unmodified biomass to be used for high performance applications due to its inherent hydrophilic nature and poor thermal resistance. Efforts have been made in the industry to improve these properties. For example, compatibilizers such as polypropylene-graft-maleic anhydride are melt blended with biomass additives to improve interfacial adhesion of the biomass to the hydrophobic recycled plastics. However, this is not cost-effective and the resulting effect on the bulk properties of the recycled polymer are nominal at best. Moreover, it does not address the growing public concern of the polymeric composite's environmental impact.

There exists an industrial need to improve the material properties of biomass to broaden potential market applications as an environmentally friendly, sustainable filler. In particular, there is a need for adding more functionality to biomass additives to improve the mechanical and thermal properties of reclaimed or recycled materials. The improvements described herein will allow biomass additives to be melt-blended into recycled plastics at elevated temperatures to produce not only single-use products but also high performance, durable goods for applications, for example, in the automotive and food industries.

### BRIEF DESCRIPTION OF THE DRAWINGS

FIG. 1A shows comparison of the amount of carbon dioxide sequestered by biomass sorghum, switchgrass, and pine.

FIG. 1B illustrates the effect of fillers on heat distortion temperatures (HDT) of polypropylene (PP).

FIGS. 2A-2C shows tensile test results for PP-TS (heat-treated biomass) compounds.

FIGS. 3A-3C shows tensile test results for LLDPE (linear low-density polyethylene)-TS (heat-treated biomass) compounds.

FIGS. 4A-4C shows the comparison of tensile results between PP-TS and LLDPE-TS compounds.

FIG. 5A shows heat distortion temperature (HDT) for PP-TS compound.

FIG. 5B shows heat distortion temperature (HDT) for LLDPE-TS compound.

FIG. 6A shows differential scanning calorimetery (DSC) curves for PP-TS compounds.

FIG. 6B shows differential scanning calorimetery (DSC) curves for PP-GTS (ground TS) compounds.

FIG. 7A shows differential scanning calorimetery (DSC) curves for LLDPE-TS compounds.

FIG. 7B shows differential scanning calorimetery (DSC) curves for LLDPE-GTS compounds.

FIG. 8A shows thermo gravimetric analyses (TGA) of carbon black.

FIG. 8B shows thermo gravimetric analyses (TGA) of TS.

FIG. 9A shows TGA of PP-TS.

FIG. 9B shows TGA of PP-GTS.

FIG. 10A shows TGA of LLPDE-TS.

FIG. 10B shows TGA of LLPDE-GT S.

FIGS. 11A-11C shows water intake of PP-TS composites under different conditions.

FIGS. 12A-12C shows water intake of PP-GTS composites under different conditions.

FIGS. 13A-13C shows thickness swelling of PP-TS composites under different conditions.

FIGS. 14A-14C shows thickness swelling of PP-GTS composites under different conditions.

FIGS. 15A-15C shows water intake of LLDPE-TS composites under different conditions.

FIGS. 16A-16C shows water intake of LLPDE-GTS composites under different conditions.

FIGS. 17A-17C shows thickness swelling of LLPDE-TS composites under different conditions.

FIGS. 18A-18C shows thickness swelling of LLPDE-GTS composites under different conditions.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The feature or features of one embodiment may be applied to other embodiments, even though not described or illustrated, unless expressly prohibited by this disclosure or the nature of the embodiments.

Unless defined otherwise, all technical and scientific terms used herein generally have the same meaning as commonly understood by one of ordinary skill in the art to which this disclosure belongs. The definitions below are intended to be used as a guide for one of ordinary skill in the art and are not intended to limit the scope of the present disclosure. Mention of tradenames or commercial products is solely for the purpose of providing specific information or examples and does not imply recommendation or endorsement of such products.

The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a composition or formulation that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps. Any embodiment of any of the compositions, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

“Recycled” or “reclaimed” in this context means the process of recovering waste plastic and reprocessing it into a wide array of end products. Typically, the waste plastic is sorted into different polymers and then melt mixed in an extruder. The extruded strands are then cooled, pelletized, and subsequently processed via injection molding or other known polymer processes to form the desired product. The term “recycled” or “reclaimed” plastic may be a homogenous or heterogeneous mixture of various different types of plastics. The types of plastics that can be “recycled” or “reclaimed” can include but are not limited to polypropylene (PP), low-density polyethylene (about 0.910 to about 0.940 g/cm³) (LDPE), high-density polyethylene (about 0.930 to about 0.970 g/cm³) (HDPE), polystyrene (PS), and/or combinations therein.

“Biomass” in this context means plant-based material generally containing hemicellulose, cellulose, and lignin. It can also mean organic residues obtained from harvesting and processing of agricultural crops. Examples of biomass can include but are not limited to native sources such as rice straw, wheat straw, cotton, corn stover, sorghum, biomass sorghum, yellow pine, almond shells, nut shells, crop residues, wood byproducts, agricultural residue, and forest litter.

“Biomass Sorghum” in this context means a perennial sorghum species that can reach heights of greater than 10 feet.

“Additive” in this context means a fiber or mineral which is melt-blended into a polymer to modify its properties.

“Heat-treated” in this context means pyrolysis of biomass under an inert atmosphere such as nitrogen or argon at temperatures between about 400° and about 500° C. for example 400° to 450° C. or 450° to 500° C., for a certain residence time for example between 30 to 180 minutes. The temperature and residence time chosen for the process will determine the degree of heat treatment of the fibers. During the heat treatment process, hemicellulose, amorphous cellulose, and volatile organic acids and oils within the fibers are converted to a densified brown to black uniform solid biomass, becoming a more hydrophobic product.

“Heat deflection temperature” or “heat distortion temperature” means a temperature that is determined by heating the polymer material and noting the point in which significant softening has occurred, allowing the sample to be readily pliable. Improved heat resistance and improved thermal stability correspond to higher heat deflection temperatures.

“Improved barrier properties” means having a contact angle value higher than unmodified recycled or reclaimed plastic. Contact angle is one of the common ways to measure the wettability of a surface or material. Wetting refers to how a liquid deposited on a solid substrate spreads out. The wetting is determined by measuring the contact angle which the liquid forms in contact with solids. The wetting tendency is larger the smaller the contact angle or the surface tension is. A wetting liquid is a liquid that forms a contact angle with the solid which is smaller than 90° . A non-wetting liquid creates a contact angle between 90° and 180° with the solid.

“Improved barrier properties” also means having the ability to decrease the oxygen transmission rate (OTR). OTR is an important factor in measuring the effectiveness of a barrier material, particularly film, laminates, or plastic-coated papers.

The present disclosure may be understood more readily by reference to the following detailed description of embodiments and to the Figures and their previous and following description.

Disclosed herein are methods to process biomass materials or agricultural feedstocks for industrial or agricultural use. In some embodiments, the biomass materials are sourced from a Combined Remediation Biomass and Bio-Product Production (CRBBP) Process detailed in U.S. Pat. No. 10,086,417 (the '417 patent). The CRBBP process cost-effectively remediates contaminated and/or stabilizes impacted land and water, using an enhanced phytoremediation and soil stabilization capabilities of the prodigious root systems of certain bio-crops; then converts the resulting, cost-effective source of biomass into a variety of bio-products, including: biochars, to increase soil productivity; fillers or extenders, which are used in industrial applications such as to make stronger, lighter and heat and water-resistant plastics; and a bio-coal, which can be co-fired in coal-fired power plants, with minimal equipment upgrades, to proportionately reduce their carbon and chemical pollution. Other biomass agriculture materials such as rice straw, wheat straw, cotton, corn stover, sorghum, biomass sorghum, yellow pine, almond shells, nut shells, agricultural residue, and forest litter can be similarly processed for industrial and agricultural use.

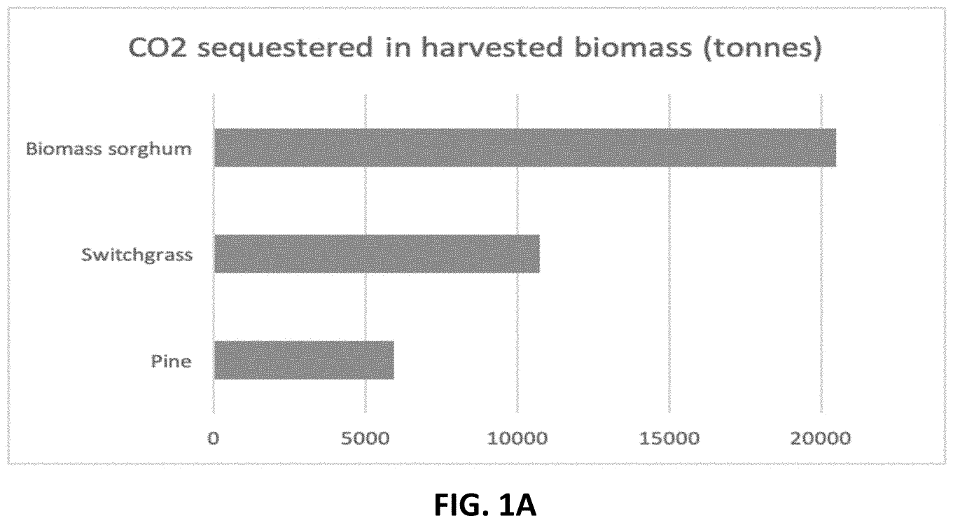

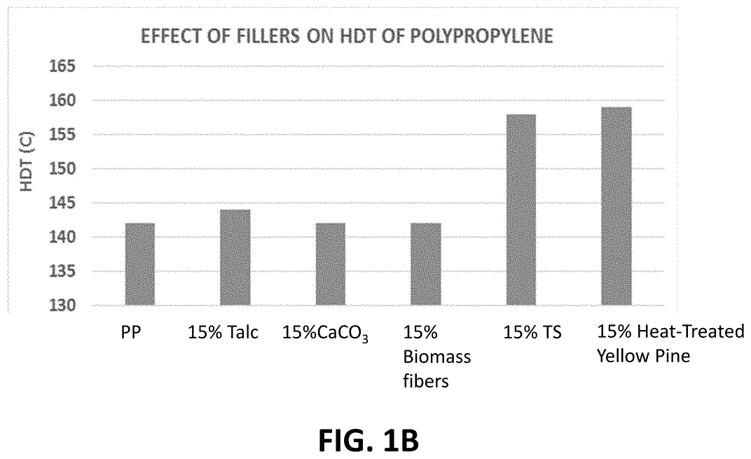

Biomass sorghum disclosed in the '417 patent in particular, captures nearly 4 times as much CO₂ as trees as show in FIG. 1A based on studies performed by Dr. Daniel Sanchez of University of California-Berkeley on relative amounts of CO₂ captured over 15-year period from 100-acre plot of forage sorghum, switchgrass, and pine. As shown in FIG. 1, biomass sorghum captures about twice as much CO₂ compared to switchgrass and about four times as much CO₂ compared to pine. Biomass sorghum is used in the present disclosure to produce heat-treated biomass fillers.

One of the technologies to process biomass is called torrefaction, which also serves as a means to add value to both plant and woody materials. Torrefaction is a mild pyrolysis method whereby biomass is heated between 200-300° C. under an inert atmosphere to remove most of its inherent moisture and some volatile components. It partially decomposes hemicellulose fractions, creating an energy rich coal-like bioproduct. Since torrefied biomass or “biocoal” retains at least 60% of its energy value it can be utilized directly as a coal substitute in power plants to generate “green” electricity. In addition to bioenergy applications, torrefied biomass acts as a useful additive in plastics to produce composite plastics.

Using fillers produced by the traditional torrefaction process, however, is found to result in a composite plastic material with far too many bubbles. Disclosed herein is a revised process of making biomass derived products. Specifically, biomass materials such as wood and biomass Sorghum materials are treated beyond the temperature and residency times associated with traditional torrefaction to further reduce volatile organic compounds to produce a heat-treated biomass filler. When the heat-treated biomass fillers are blended with polymers, the resulting composite plastic material is found to have superior properties compared to the composite plastic material produced with torrefied biomass.

In one embodiment, disclosed herein are heated-treated biomass fillers used as a polymer additive in commodity plastics, such as polypropylene (PP), polyethylene terephthalate (PET), and polyethylene (PE), as well as bioplastics such as polylactic acid (PLA) and polyhydroxyalkanoate (PHA). Biomass from various sources such as sorghum, wood residues, almond shells, walnut shells, biomass sorghum and straws can be heat-treated and ground to produce heat-treated biomass fillers to be mixed with polymers to produce polymeric composites. The polymeric composite is shown to have comparable and sometimes superior commercially relevant physical properties such as process ability, heat distortion temperature, rigidity of the polymeric composite, and colorant properties when compared to polymeric composite produced with traditional fillers such as carbon black. In some embodiments, the heat-treated biomass filler is primarily used as a colorant.

Improved heat deflection for example is sought by the polymer industry for plastic products that do not soften as easily in hot conditions, such as under intense sunlight on hot days. When the heat-treated biomass filler is compared with fillers that are often applied commercially for this purpose, namely talc, calcium carbonate, and biomass fibers, it produces a plastic product that does not soften as easily under elevated temperatures without adversely affecting basic processing parameters. Thus, the heat-treated biomass filler disclosed herein introduce improved end-use properties without adding significant processing or material costs.

In one embodiment, biomass sorghum is heated at 400° C. for 30 minutes and then cooled and ground to a power of having a particle size of 100um. The heat-treated biomass sorghum, which is gray to black in color, can be used to displace carbon black in polymeric composites and provides additional advantageous mechanical properties beyond adding color. For example, when 2-20% heat-treated biomass sorghum is added to polypropylene, it improved its heat deflection temperature and increased its rigidity. When the heat-treated biomass sorghum filler is compared with fillers that are often applied commercially for this purpose, namely talc, calcium carbonate, and biomass fibers, it produces a plastic product that does not soften as easily under elevated temperatures without adversely affecting basic processing parameters. Improved heat deflection is sought by the polymer industry for plastic products that do not soften as easily in hot conditions, such as under intense sunlight on hot days. Thus, the heat-treated biomass sorghum filler disclosed herein introduce improved end-use properties without adding significant processing or material costs. In one embodiment, instead of biomass sorghum, yellow pine is used and achieved results that are similar to that of biomass sorghum.

FIG. 1B outlines the heat deflection temperature for TS compared with fillers that are often applied commercially for this purpose, namely talc, calcium carbonate, and biomass fibers. These data confirm that TS filler creates a plastic product that does not soften as easily under elevated temperatures and without adversely affecting basic plastic composition processing parameters. Improved heat deflection is sought by the polymer industry for plastic products that do not soften as easily in hot conditions, such as under intense sunlight on hot days. Thus, the method and composition disclosed herein has the potential to introduce improved end-use properties without adding significant processing or material costs.

The heat-treated biomass filler can be used to improve the property of common industry polymers such as polypropylene (PP). PP is a commodity plastic commonly used in a wide array of applications, such as automotive interior parts, clothing, low density packaging, and structural foam because of its toughness and good chemical resistance. However, such widespread use of PP has created a problem relating to the disposal of the thermoplastic. Single use products made of PP end up in landfills as waste. Because PP degrades slowly in landfills, waste management has become a significant issue. Fortunately, polypropylene, in addition to other plastics such as PET, polystyrene (PS), and PE, can be recycled, and most communities engage in some form of active recycling programs.

There are several available methods for recycling plastics. One method involves homogenous recycling, as disclosed in U.S. Pat. Nos. 3,567,815 and 3,976,730. In U.S. Pat. No. 3,567,815, approximately 5-30% high density polystyrene was melt-blended to post-consumer low density polystyrene to improve its processability. Addition of small quantities of high-density polystyrene produced unusually large increases in extrusion rate and relatively uniform thickness gauge on the sheet extrudate. In U.S. Pat. No. 3,976,730, a method was presented in which melt scrap polyethylene was melt-blended into virgin resin at concentrations of 20 to 40%. Another method as described in U.S. Pat. No. 5,145,617 involved mixing different plastics. The common theme described in these patents—a process known in the art as reclamation—is that the plastic waste materials are being recycled in the form of blends via various polymer processes such as extrusion. The method allows for the conversion of the plastic waste materials into a variety of new materials. However, reclamation often produces materials with reduced mechanical and thermal properties. This is loosely termed “down cycling” the plastic rather than “recycling” and it affects the end-use value of the reclaimed product.

To improve or broaden the range of properties of the reclaimed materials, certain additives are melt-blended via extrusion into recycled plastics. In some embodiments, the present disclose provides a polymeric composite containing recycled or reclaimed plastics blended with biomass fillers. The recycled or reclaimed plastics in this disclosure can be polypropylene (PP), low-density polyethylene (LDPE), high-density polyethylene (HDPE), polystyrene (PS), and/or combinations of the aforementioned plastics. The biomass additives in this disclosure are heat-treated biomass from agricultural feedstocks, such as sorghum, yellow pine, almond, walnut, pistachio shells, almond hulls, rice hulls, and biomass sorghum, or combination thereof. The polymeric composite is prepared by melt-blending the recycled or reclaimed plastics along with heat-treated biomass via extrusion. The resultant polymeric composite has a higher heat deflection temperature and better mechanical and barrier properties than the unfilled polymer.

In some embodiments, the “recycled” or “reclaimed” polymer has a number average molecular weight between about 10,000 and about 1,000,000 Daltons (e.g., 10,000-1,000,000 Daltons), for example in the range of about 30,000 to about 100,000 Daltons (e.g., 30,000 to 100,000 Daltons). In some embodiments, the “recycled” or “reclaimed” polymer has a melt flow index (MFI) between about 2 and about 10 g/10 min at 230° C. (e.g., 2-10 g/10 min at 230° C.), for example in the range of about 4 and about 8 g/10 min at 230° C. (e.g., 4-8 g/10 min at 230° C.). In some embodiments, the biomass has been heat-treated to yield a heat-treated biomass which degrades between about 300° and about 400° C. (e.g., 300°-400° C.), for example from about 300° to about 375° C. (e.g., 300°-375° C.). In some embodiments, the heat-treated biomass filler has a particle size between about 1 to about 1000 microns (e.g., 1-1000 microns), for example from about 50 to about 200 microns (e.g., 50-200 microns).

In some embodiments, the biomass materials are heat treated through pyrolysis of biomass in temperature from about 400° to about 500° C. under non-oxygenated conditions such as inert nitrogen, carbon dioxide, or argon environment, for about 30 min to about 180 min. The temperature and residence time chosen for the process determines the degree of heat treatment of the fibers. Biomass may come from but is not limited to fibers from native sources such as rice straw, wheat straw, cotton, corn stover, sorghum, biomass sorghum, nut shells, yellow pine, almond, other agricultural residue, and forest litter. In some embodiments, the heat-treated biomass has been heat-treated between about 400° to about 500° C. (e.g., 400° -500° C.) under non-oxygenated conditions, for example between about 400° to about 450° C. (e.g., 400°-450° C.). In some embodiments, the heat-treated biomass has been heat-treated between about 30 to about 180 minutes (e.g., 30-180 minutes) under non-oxygenated conditions, for example between about 30 to about 60 minutes (e.g., 30-60 minutes).

At least about 15% of the carbon of the biomass material is consumed during the heat treatment process, leaving at least about 85% of the carbon of the biomass material in the heated treated biomass. In some embodiments, at least about 20% of the carbon of the biomass material is consumed during the heat treatment process, leaving at least about 80% of the carbon of the biomass material in the heated treated biomass. In some embodiments, at least about 25% of the carbon of the biomass material is consumed during the heat treatment process, leaving at least about 75% of the carbon of the biomass material in the heated treated biomass.

In some embodiments, the heat-treated biomass is from about 5 to about 40 percent (e.g., 5-40 percent) of the total weight of the polymeric composite, for example from about 15 to about 30 percent (e.g., 15-30 percent). In some embodiments, the “recycled” or “reclaimed” plastic polymer is about 50 to about 90 percent (e.g., 50-90%) of the total weight of the polymeric composite, for example, in the range of about 60 to about 80 percent (e.g., 60-80%).

In some embodiments, various articles of manufacture may be formed with polymeric composites of the present disclosure. For example, processes such as extruding, injection molding, sheet forming, blow molding, and thermoforming may be used to create articles including cutlery, containers for packaging, hot server items, hard plastic casings, 3-D printed items, 3-D printer ink, and other items. It should be appreciated that a person of ordinary skill in the art may select any suitable known process to create any article of manufacture from the polymeric composite of this disclosure.

While the present disclosure may be embodied in many different forms, there are described in detail herein specific embodiments of the present disclosure to serve as examples to understand. The present disclosure is an exemplification of the principles of the present disclosure and is not intended to limit the present disclosure to the particular embodiments illustrated. All patents, patent applications, scientific papers, and any other referenced materials mentioned herein are incorporated by reference in their entirety. Furthermore, the present disclosure encompasses any possible combination of some or all of the various embodiments and characteristics described herein and/or incorporated herein. In addition, the present disclosure encompasses any possible combination that also specifically excludes any one or some of the various embodiments and characteristics described herein and/or incorporated herein.

The amounts, percentages and ranges disclosed herein are not meant to be limiting, and increments between the recited amounts, percentages and ranges are specifically envisioned as part of the present disclosure. All ranges and parameters disclosed herein are understood to encompass any and all sub-ranges subsumed therein, and every number between the endpoints. For example, a stated range of “1 to 10” should be considered to include any and all sub-ranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions (e.g., reaction time, temperature), percentages and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present disclosure. As used herein, the term “about” refers to a quantity, level, value, or amount that varies by as much as 10% to a reference quantity, level, value, or amount.

Unless defined otherwise, all technical and scientific terms used herein have the same meaning as commonly understood by one of ordinary skill in the art to which the present disclosure belongs. Although any methods and materials similar or equivalent to those described herein can be used in the practice or testing of the present disclosure, the example methods and materials are now described.

The following examples are intended only to further illustrate the present disclosure and are not intended to limit the scope of the present disclosure as defined by the claims.

### EXAMPLES

Biomass sorghum is heated treated following the procedure disclosed herein to produce as produced heat-treated biomass sorghum (TS). The composites of polypropylene (PP), as well as linear low-density polyethylene (LLDPE) thermoplastics filled with up to 50 wt. % TS are evaluated to assess its efficacy in improving mechanical, thermal and water uptake properties. PP and LLDPE was mixed with as-produced and ball-milled heat-treated biomass sorghum (GTS), by adding in different percentages. Mixing was done using a mini compounder at 190° C.-200° C. and 165° C. using PP and LLDPE, respectively at 20 rpm mixing rate for 20 minutes. After compounding, three or more dog-bone shape samples were formed from the same batch, and for each condition, via DSM Research Micro-Injection molding machine at temperatures 190° C. and 160° C. for PP and LLDPE, respectively. The mechanical properties of the blends obtained in this manner were investigated by tensile testing and the fracture surfaces of the samples were observed after the tensile test by using scanning electron microscopy (SEM). Thermal behaviors of blends were characterized by using Differential Scanning calorimetry (DSC) analyses. Thermal stability of composites was determined by using thermo gravimetric analysis (TGA) under elevated temperature. Heat Distortion Temperatures (HDT) were obtained using Dynamic Mechanical Analyses (DMA). Environmental stability of the composites was assessed using liquid absorption and swelling experiments over a 7-day period by immersion in pure water with pH 7, 0.01 M Dilute HCl solution with pH 2 and 0.01 M dilute NaOH solution with pH 12.

Elastic modulus of PP increased with an increasing TS amount for both as produced and ground PP/TS specimens. No significant difference has been observed between as produced and ground heat-treated biomass sorghum filler specimens. On the other hand, maximum stress and strain at maximum stress decreased with increasing amount of heat-treated biomass sorghum filler.

Elastic modulus and maximum stress values for LLDPE increased with increasing amount of heat-treated biomass sorghum filler for both as produced and ground LLDPE/TS specimens. Strain at maximum stress decreased with increasing amount of heat-treated biomass sorghum filler. When the trends of the elastic moduli for PP/TS and LLDPE/TS composites were compared, the effect of TS amount was found to be similar on both composites, resulting in increasing behavior for the elastic moduli in similar proportions. In the case of strain values at maximum stress, TS addition affected LLDPE more than PP with higher amounts of strain reduction. The maximum stress values presented opposite behaviors with those for LLDPE increasing while those for PP decreasing. At 50% wt. TS amount added, the maximum stress and the corresponding strain values for both LLDPE/TS and PP/TS composites became very close.

There is no appreciable change in melting temperatures for the PP/TS and LLDPE/TS composites with TS filler addition up to 50 wt. %.

Heat Distortion Temperature (HDT) of PP/TS and humidified PP/TS composites increased with an increasing amount of TS. When compared with neat PP, up to 31.72° C. and 30.92° C. increases were obtained for heat distortion temperatures of PP/TS and humidified PP/TS composites, respectively, with TS filler addition of up to 50 wt. %. The efficacy of larger TS particles is better in increasing the heat distortion temperature for the composite in comparison to the use of smaller ground TS particles. HDT of LLDPE/TS increased with an increasing amount of TS resulting in 25.57° C. enhancement. The carbon conversion of TS was determined to be approximately 78.42% by using Thermogravimetric Analysis (TGA).

Thermal stability of PP/TS, PP/GTS, LLDPE/TS, and LLDPE/GTS composites were found to be higher than the neat PP and LLDPE materials, and their stability increased with increasing amount of TS/HGTS fillers, as determined using TGA by the residual weight method. The residual weights of the TS-filled composites were slightly less than those for their HGTS-filled counterparts.

Among the TS filled polymers tested, for the PP/TS composite, the maximum water uptake was ˜6% and the maximum thickness swelling was ˜4.5%. For the LLDPE/TS composite, the maximum water uptake was ˜8% and the maximum thickness swelling was ˜3.5%.

### Example 1: Preparation of Heat-treated Biomass Sorghum (TS)

Biomass sorghums were generously donated by the Agri-Tech Producers, LLC (Columbia, S.C.). Prior to heat treatment, the biomass sorghum was ground using an industrial Wiley mill. Thermogravimetric analysis under nitrogen was performed before the heat treatment procedure to optimize the heat treatment temperatures. Two criteria were established: (1) increased hydrophobicity of the biomass and (2) relatively high yields after heat treatment. The increased hydrophobicity would result in improved fiber adhesion to the polymer matrix, providing improvements in mechanical and thermomechanical properties of the biocomposites. Secondly, yields greater than 50 by weight % of the starting biomass were sought in order for the process to be economically viable. The ground biomass sorghum was treated at different temperatures, such as 300°, 350°, 400°, 450°, and 500° C. The yield at 400° C. was roughly 60 by weight % of the starting material.

Increasing the heat treatment temperature of the unmodified biomass sorghum decreased the overall percent yield of the heat-treated biomass. A dramatic increase in mass loss was observed between 230° and 260° C. At 300° C., — 40% of the original mass remained. This is in line with the mechanism of heat treatment. Breakdown of the cellulose and hemicellulose occurs, producing gases and volatile organics.

The biomass sorghum was heat-treated using a high temperature convection furnace. The size of the chamber limited the amount of biomass that could be heat-treated at one time to approximately 1 kg. To prevent combustion of the biomass during the heating process, an inert atmosphere was maintained using nitrogen gas at a flow rate of approximately 150 mL/min. The biomass was heated to 400° C. and held at temperature for 0.5 h. The biomass was then allowed to cool to room temperature in the inert atmosphere. Thermogravimetric analysis (TGA) of the unheat-treated and heat-treated biomasses was conducted using a Perkin Elmer Pyris 1 TGA. A temperature ramp of 10° C. per minute from room temperature to 500° C. was used to analyze the biomass. The heat-treated biomass sorghum was ground further and then sieved to produce ball-milled heat-treated biomass sorghum (GTS) that has a particle size in the range of about 100 to about 200 microns.

### Example 2 Preparation of Polymeric Composite Materials

The polymeric composites of PP/TS and LLDPE/TS were prepared by adding a different percentage of heat-treated biomass sorghum (labelled as TS) filler with commercial PP (Himount, MFI is 73 g/10 min and Mw is 144,000) and LLDPE (courtesy of Americhem) thermoplastic polymers by using PL 2000 CW Brabender mini compounding machine (C.W. Brabender Instruments Inc., South Hackensack, N.J.), which can prepare up to 35 g material. Before compounding, TS powders were ground with ball mill and alumina balls for 24 hours. Particle size distributions of ground TS were analyzed by a Malvern Mastersizer m+Ver.2.15 model laser diffraction particle size analyzer.

Average particle size of ground particles was found to be 465 nm. TS powders were used as produced and 24 h ground (labelled as GTS) by considering particle size results.

Polymer and TS were mixed at temperatures 190° C.-200° C. and 165° C. using PP and LLDPE, respectively using 20 rpm mixing rate for 20 minutes. After compounding, five dog-bone shape samples and six rectangular samples were formed from the same batch via DSM Research Micro-Injection molding machine at temperatures 190° C. and 160° C. for PP and LLDPE, respectively.

### Example 3 Tensile Test

Instron (Noorwood, Mass.) 5567 model universal electromechanical test machine was utilized to measure the following mechanical properties: elastic modulus, maximum tensile stress at break point and strain at maximum stress point of polymer/TS compounds, as well as neat PP and neat LLDPE. The crosshead speed was 50 mm/min and a 1 kN load cell was used. Five dog-bone shape specimens were tested based on ASTM Type V standard for each composition. Load and extension values were obtained as an output and converted to tensile stress, tensile strain and Young's modulus values by using the input dimensions of samples via Bluehill2 software.

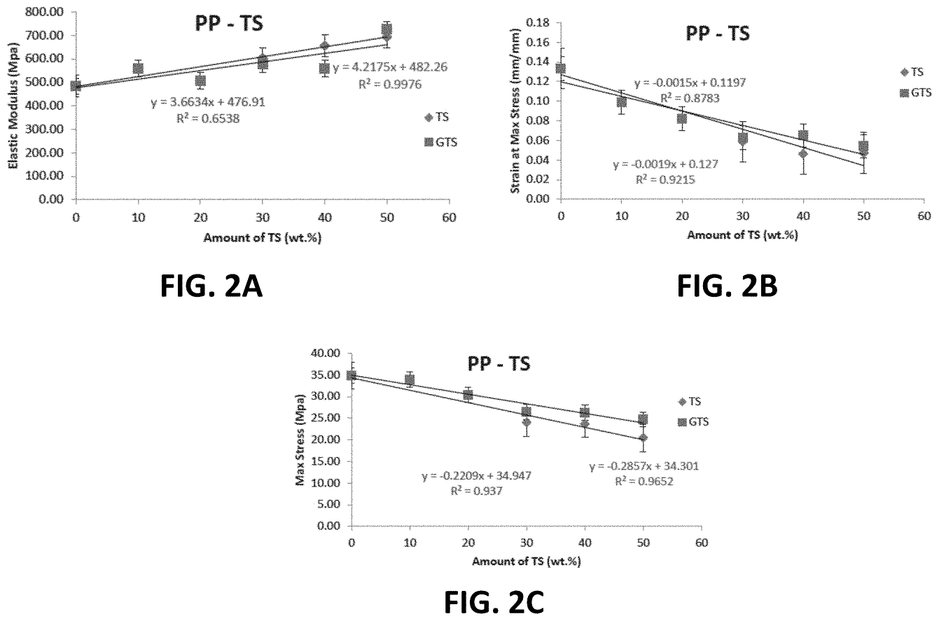

Elastic modulus of PP increased with an increasing TS amount for both as produced and ground PP/TS specimens. No significant difference has been observed between as produced and ground TS-filler specimens. On the other hand, maximum stress and strain at maximum stress decreased with increasing amount of TS filler. Decrease in elongation can be attributed to local deformation process which prevents the necking of composites with an increasing filler amount, and the decrease in maximum stress can be attributed to increasing brittleness of the TS/PP composite. The PP/TS composite showed slightly lower values than PP/GTS composite at higher filler loadings due to increasing interfacial strength when using nanometer size (ground) fillers. The tensile test results for PP/TS are shown in FIG. 2A-2C.

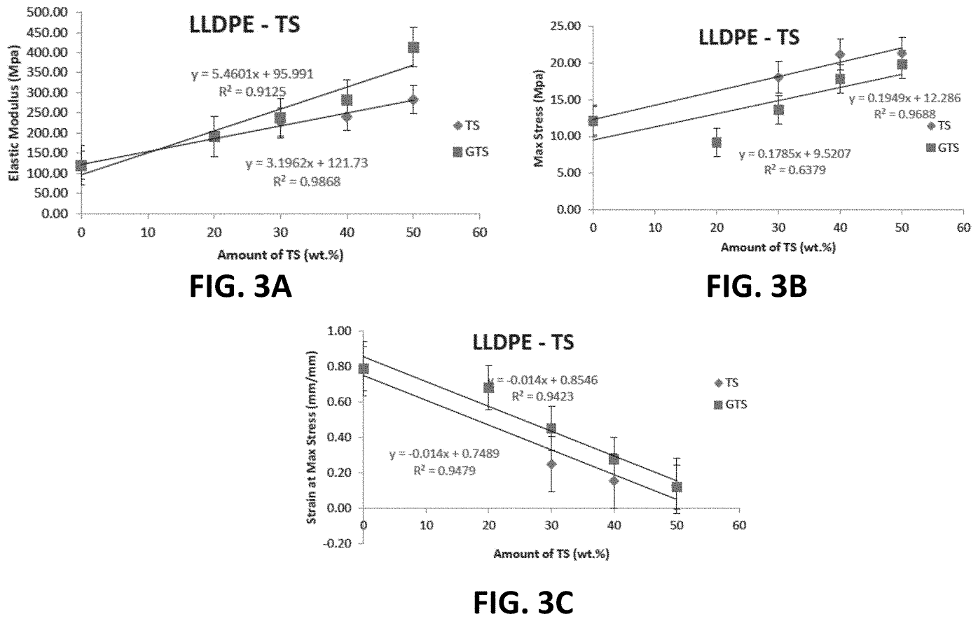

Elastic modulus and maximum stress values for LLDPE increased with increasing amount of TS filler for both as produced and ground LLDPE/TS specimens. Strain at maximum stress decreased with increasing amount of TS filler. Decrease in elongation can be attributed to local deformation process which prevents the necking of composites with increasing amount of filler. On the other hand, high deformation capacity of LLDPE (in comparison to PP) prevents onset of brittleness with TS addition, which allows increases in maximum stress values for the LLDPE/TS composite with increasing amounts of TS filler addition. The tensile test results for LLDPE/TS are shown in FIG. 3A-3C.

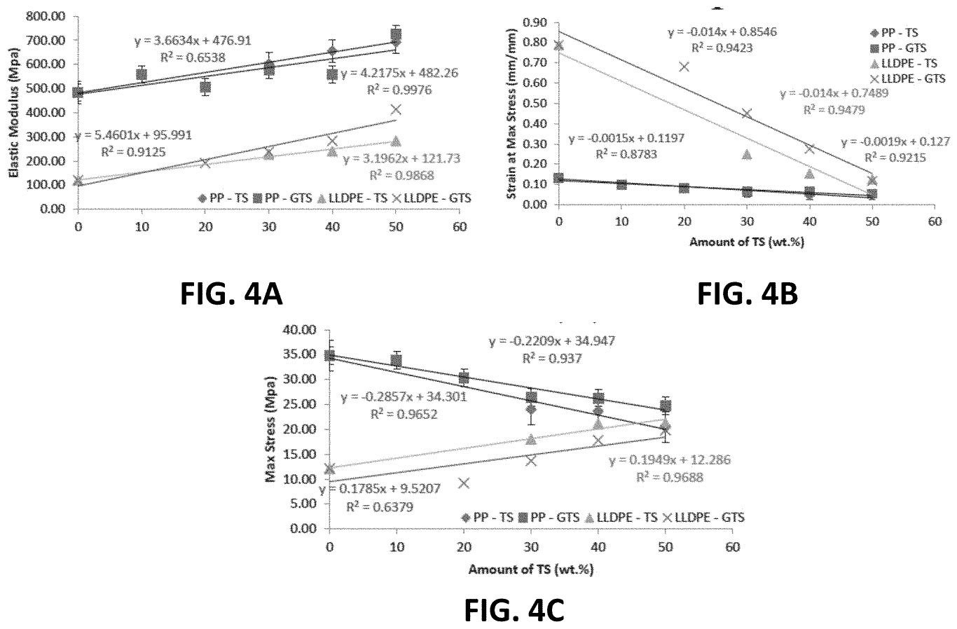

When the trends of the elastic moduli for PP/TS and LLDPE/TS composites were compared, the effect of TS amount was found to be similar on both composites, resulting in increasing behavior for the elastic moduli in similar proportions. In the case of strain values at maximum stress, TS addition affected LLDPE more than PP with higher amounts of strain reduction. The maximum stress values presented opposite behaviors with those for LLDPE increasing while those for PP decreasing. At the highest TS amount added (50% wt.) the maximum stress and the corresponding strain values for both LLDPE/TS and PP/TS composites became very close. Comparison of Tensile Results between PP-TS and LLDPE-TS Compounds are shown in FIG. 4A-4C.

### Example 4 Dynamic Mechanical Analyses (DMA)

DMA analyses were performed to obtain heat distortion temperatures for polymer/TS compounds, as well as neat PP and neat LLDPE polymers. DMA—TA instrument Q800 (TA Instruments, New Castle, Del.) was used under a nitrogen environment with three-point bending apparatus under constant stress (0.455 MPa) based on ASTM International Standard D648 using 50 mm length, 12 mm width and 1.92 depth/thickness ratio for the specimens. For each composition, three humidified and three non-humidified specimens were tested to assess any humidity effect. For that purpose, the specimens were humidified 48 h with 52% relative humidity using saturated Mg(NO₃)₂ solution at room temperature. Specimens were tested in the 35° C. to 150° C. (PP/TS) and 35° C. to 120° C. (LLDPE/TS) ranges using 10° C./min ramp rate. The temperature at 0.2 mm/mm strain was recorded as the heat distortion temperature. Neat polymers were tested as well to see the effect of TS to the heat distortion temperature.

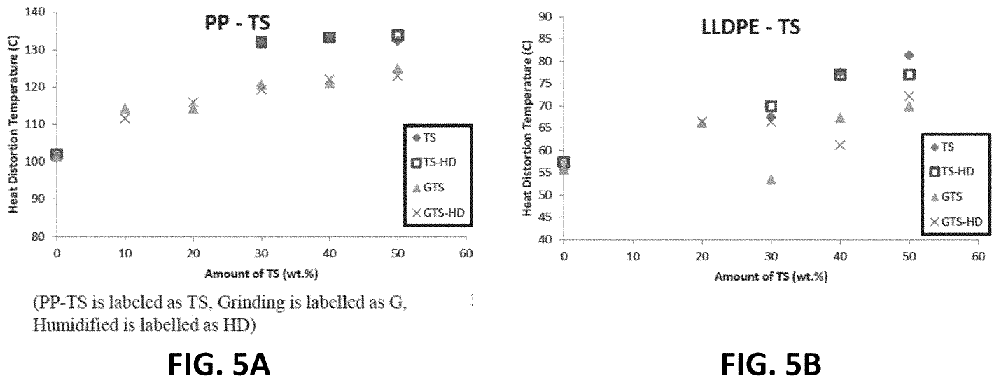

Heat Distortion Temperature (HDT) of PP/TS and humidified PP/TS composites increased with an increasing amount of TS. When compared with neat PP, up to 31.72° C. and 30.92° C. increases were obtained for heat distortion temperatures of PP/TS and humidified PP/TS composites, respectively, with TS filler addition of up to 50 wt. %. Humidifying the samples did not result in considerable changes in heat distortion temperatures. In the case of PP/ground-TS and humidified PP/ground-TS specimens; HDT increment stood at 23.53° C. and 20.97° C., respectively for the highest amount of TS addition, which indicates that the efficacy of larger (as produced) TS particles is better in increasing the heat distortion temperature for the composite in comparison to the use of smaller (ground) TS particles. The results are shown in FIG. 5A.

HDT of LLDPE/TS increased with an increasing amount of TS resulting in 25.57° C. enhancement. Humidification did not result in considerable changes until 50% TS filler addition, which provided 19.59° C. increase. LLDPE/GTS and humidified LLDPE/GTS composites had lower gains in HDT with increases of 14.15° C. and 14.73° C. increments, at most, respectively. The results are shown in FIG. 5B.

Differences obtained in HDT between as produced and ground filler added composites (PP/TS-PP/GTS composites, as well as LLDPE/TS-LLDPE/GTS composites, respectively) can be attributed to reductions in freedom of movement of polymer chains which is reduced more when porous and bigger particles were added (confinement effect) in comparison to the addition of smaller (ground) particles.

### Example 5 Differential Scanning Calorimetry (DSC)

DSC analyses were performed to obtain melting temperatures and illustrate the effect of TS addition on the thermal behavior of TS/polymer composites. A DSC-TA instrument Q200 (TA Instruments, New Castle, DE) was used under s nitrogen environment with each ˜7 g sample, and the samples were scanned from 25° C. to 190° C. at 10° C./min ramp rate.

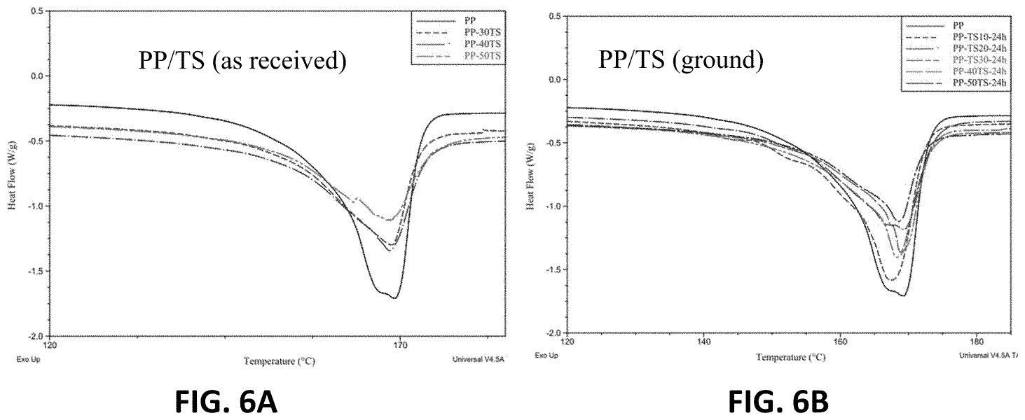

As shown in FIG. 6A, 6B, and Table 1, there is no appreciable change in melting temperature for the PP/TS composites with TS filler addition up to 50 wt. %. The enthalpic endotherm, AH, however is reduced by as much as 50.65% in comparison to the neat polymer (PP) when 50 wt. % TS is added in ground form. This result points to reduction in the degree of crystallinity for the PP matrix with TS and GTS filler addition.

TABLE 1

| | | T-melting | ΔH | ΔH RANK (%) |
|---|---|---|---|---|
| | TS wt. % | | | |
| PP | 0 | 169.18 | 108.4 | 100.00 |
| | 30 | 168.74 | 82.78 | 76.37 |
| | 40 | 168.54 | 81.24 | 74.94 |
| | 50 | 168.08 | 72.6 | 66.97 |
| | GTS wt. % | | | |
| | 10 | 167.4 | 103.2 | 95.2 |
| | 20 | 169.2 | 84.84 | 78.27 |
| | 30 | 168.29 | 86.48 | 79.78 |
| | 40 | 168.86 | 67.15 | 61.95 |
| | 50 | 168.48 | 54.9 | 50.65 |

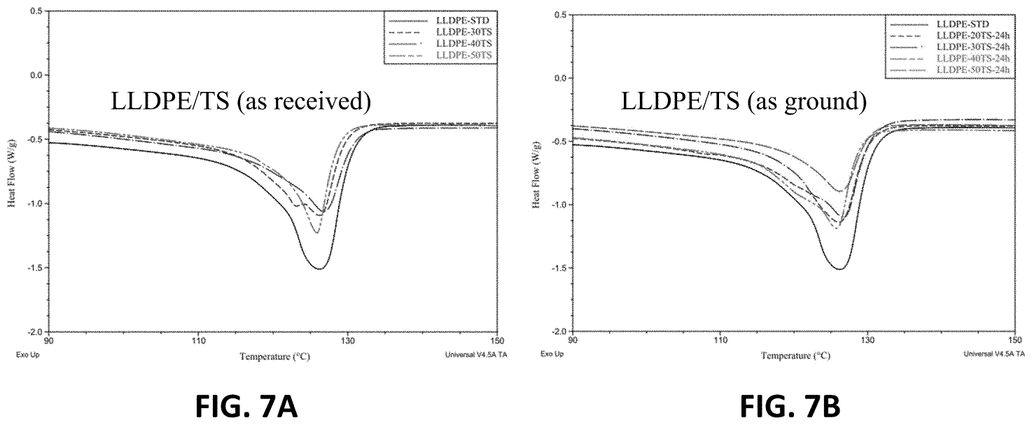

As shown in FIG. 7A, 7B, and Table 2, there is no appreciable change in melting temperature for the LLDPE/TS composites with TS filler addition up to 50 wt. %. The enthalpic endotherm, ΔH, however is reduced by as much as 49.81% in comparison to the neat polymer (PP) when 50 wt. % TS is added in ground form. This result points to reduction in the degree of crystallinity for the LLDPE matrix with TS and GTS filler addition.

TABLE 2

| | | T-melting | ΔH | ΔH RANK (%) |
|---|---|---|---|---|
| | TS wt. % | | | |
| LLDPE | 0 | 126.3 | 87.89 | 100.00 |
| | 30 | 126.24 | 61.83 | 70.35 |
| | 40 | 126.83 | 57.87 | 65.84 |
| | 50 | 125.88 | 54.98 | 62.56 |
| | GTS wt. % | | | |
| | 20 | 126.13 | 69.06 | 78.58 |
| | 30 | 126.62 | 66.22 | 75.34 |
| | 40 | 125.77 | 61.7 | 70.20 |
| | 50 | 126.14 | 43.78 | 49.81 |

### Example 6 Thermo Gravimetric Analyses (TGA)

Thermal stability of composites was determined by using TGA under elevated temperature. A TGA-TA instrument Q50 (TA Instruments, New Castle, Del.) was employed for this purpose. All specimens were heated at temperature between 550° C. and 650° C. under a nitrogen environment with 10° C./min ramp rate.

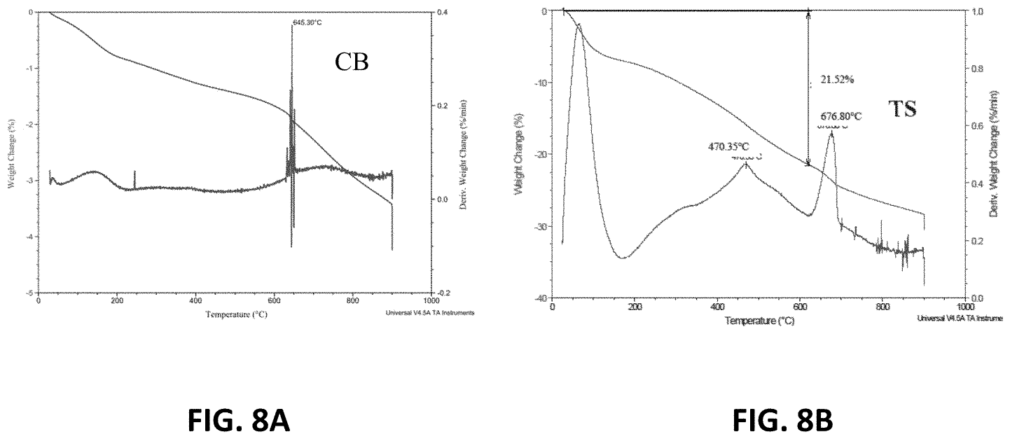

TGA curves of carbon black (CB) and TS were compared to approximately identify the carbon formation percentage after the heat treatment process of biomass sorghum, and the results are shown in FIGS. 8A and 8B. The TGA curve for CB reveals that the main CB oxidation reaction begins around 645.30° C. The TGA curve for TS, on the other hand, reveals that, prior to the heat treatment process, the first organic parts: moisture, relatively small, carbonized particles and some organics disintegrate and exhibit a broad peak. The carbonizing parts begin to react at 676.80° C. (close to the CB reaction temperature) due to heat treatment. Until the initiation of this TS reaction only 21.52 wt. % of TS has been burned, which indicates that the carbon conversion of biomass sorghum is approximately 78.42%.

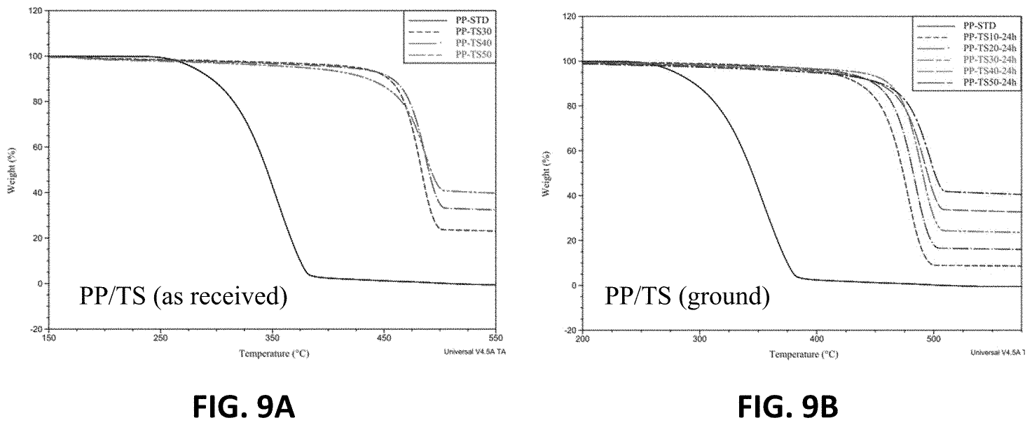

Thermal stability of PP/TS and PP/GTS composites are higher than the neat PP material, and the stability increases with increasing amount of TS filler. The residual weight of PP/TS is slightly less than that for PP/GTS. The results are shown in FIGS. 9A and 9B.

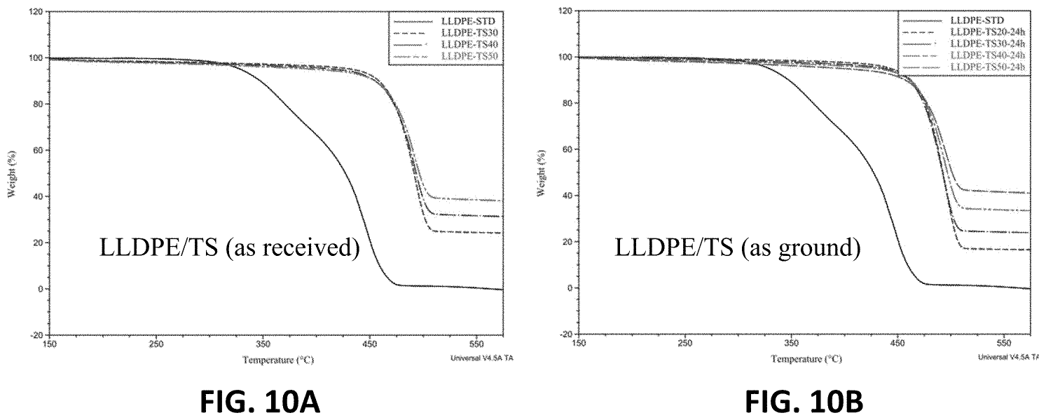

Thermal stability of LLDPE/TS and LLDPE/GTS composites are higher than the neat LLDPE material, and the stability increases with increasing amount of TS filler. The residual weight of LLDPE/TS is around 3% less than that for LLDPE/GTS. The results are shown in FIGS. 10A and 10B.

### Example 7 Water Intake and Thickness Swelling Calculations for PP/TS and LLDPE/TS Composites

PP/TS and LLDPE/TS composites were immersed into pure water with pH 7, 0.01 M Dilute HC1 solution with pH 2 and 0.01 M dilute NaOH solution with pH 12 for 7 days at room temperature. At the end of 1st, 3rd and 7th days, samples were moved out from water, HCl and NaOH solutions, liquid on surface wiped with tissue and then weight and thickness changes recorded to calculate liquid absorption and physical stability of samples, respectively by the following formulas where W and t indicate weight and thickness of samples, respectively:

$$Water Absorption = \frac{{W}_{after immersion} - {W}_{before immersion}}{{W}_{before immersion}} \times 100 \\ Thickness Swelling = \frac{{t}_{after immersion -} {t}_{before immersion}}{{t}_{before immersion}} \times 100$$

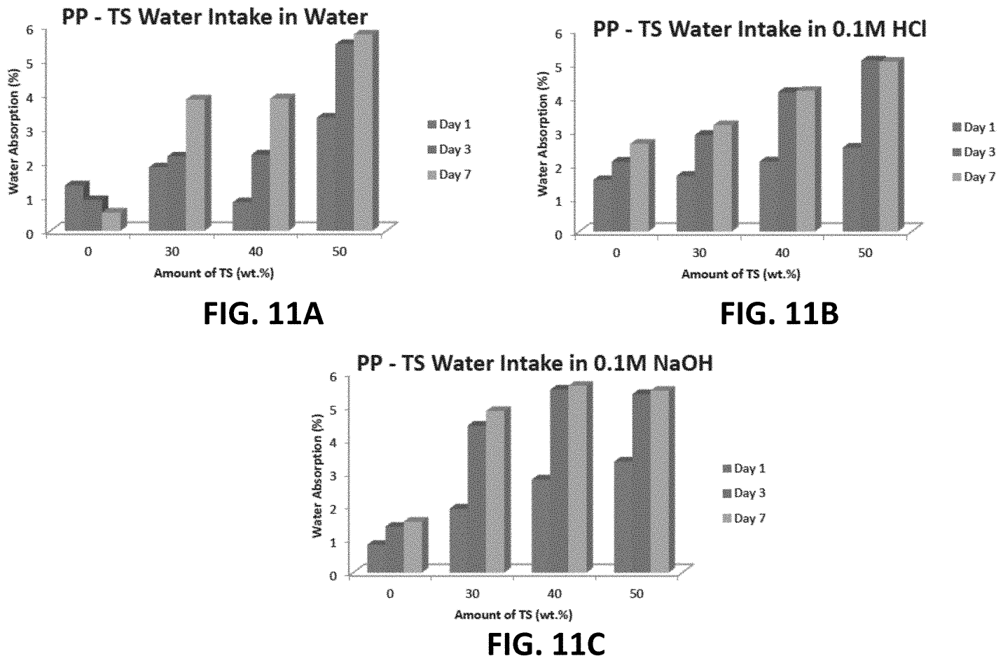

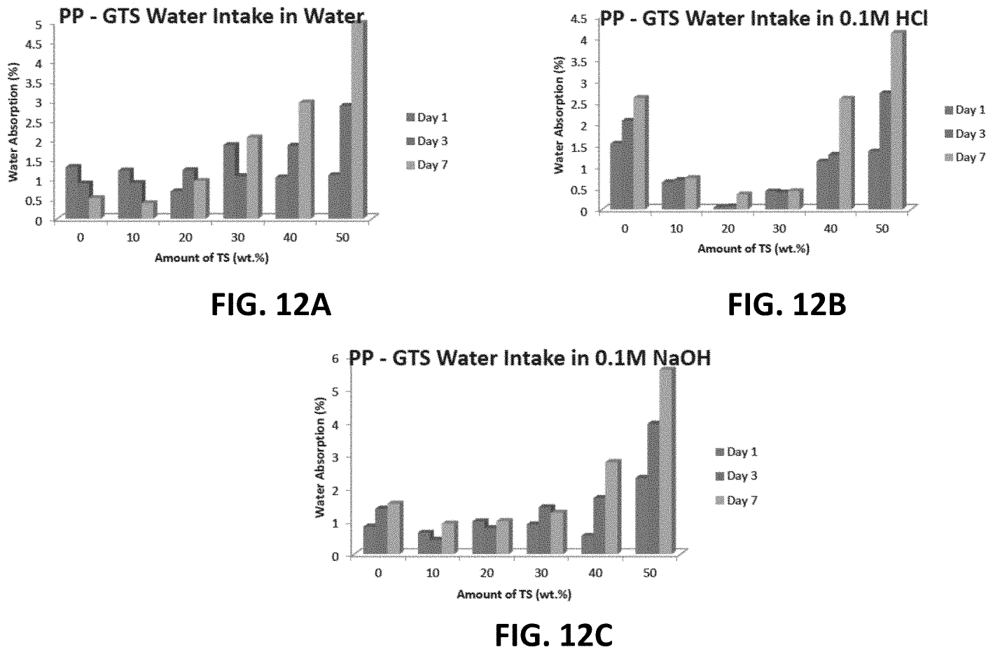

Water intake of PP/TS (as produced) composites under different conditions are shown in FIGS. 11A-11C. Liquid intake of composites increased with increasing amount of TS filler from day 1 to day 7. Composites absorb more liquid in 0.1 M NaOH solution. Water intake of PP-ground TS composites under different conditions are shown in FIGS. 12A-12C. Neat PP shows higher absorption in HCl solution in comparison to GTS filler addition of up to 40 wt. %. In general liquid intake of PP/GTS composites increased from day 1 to day 7 except the neat PP and PP/10% GTS composites in water. Up to 30 wt. % GTS amount, liquid absorption of composites decreased or did not change considerably, and this can be explained by prevention of water intake in composites via ground GTS particles. After 30 wt. % GTS, liquid intake rate increased, while such intake was minimum from the HC1 solution.

When the PP/TS (as produced) composites and PP/GTS (ground) composites are compared, it can be seen that, in general, PP/GTS absorbed less liquid than PP/TS. This can be explained by the nature of as-produced TS which has a porous structure. In the case of as-produced particles, composites absorb the liquid in and through these pores. When the TS is ground, those pores are eliminated leading to lower liquid intake.

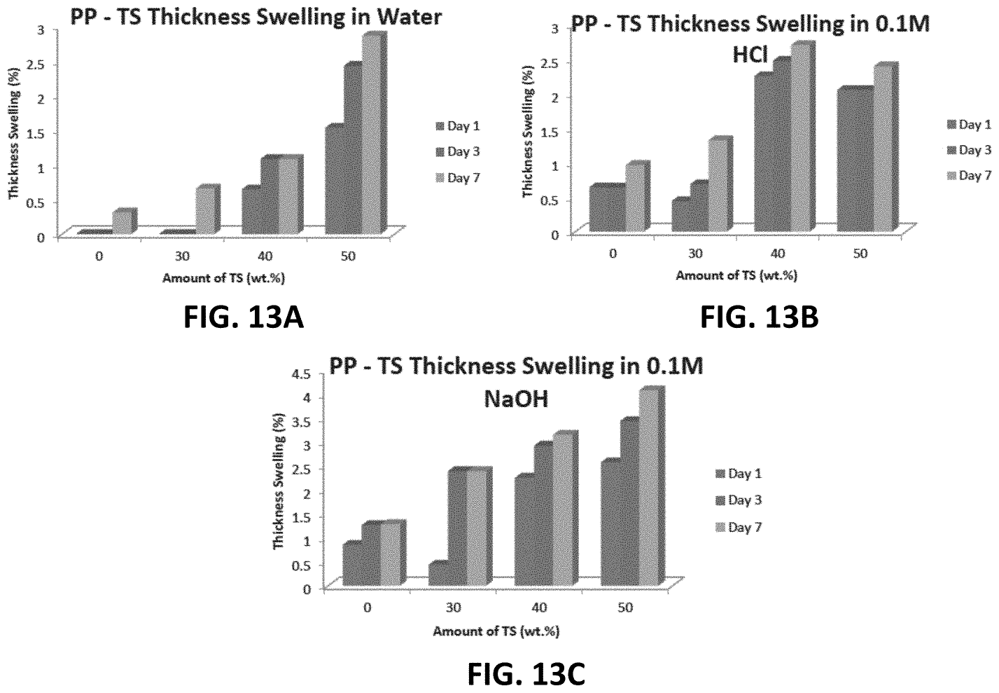

Thickness swelling of PP/TS (as produced) composites under different conditions are shown in FIGS. 13A-13C. Thickness swelling in composites increased from day 1 to day 7 with increasing amount of TS fillers. Such swelling is less in water and HCl solution than in NaOH solution.

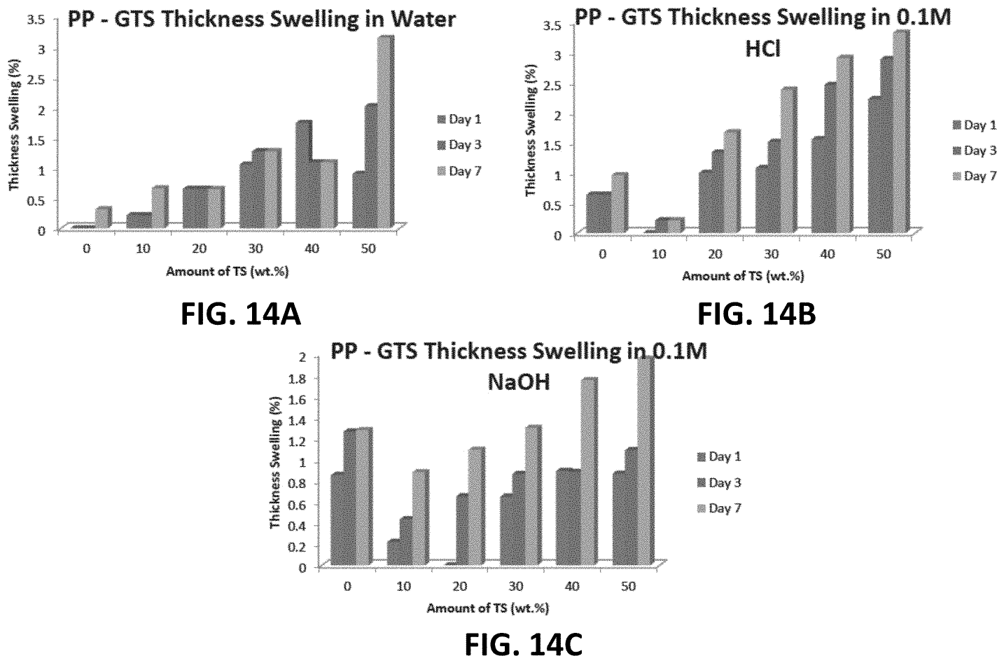

Thickness swelling of PP-ground TS Composites under different conditions are shown in FIGS. 14A-14C. Thickness swelling of composites increased with increasing amount of GTS fillers in general except for PP/10 wt. % GTS in HCl and NaOH solutions. Such swelling is less in water and NaOH solution than in HCl solution.

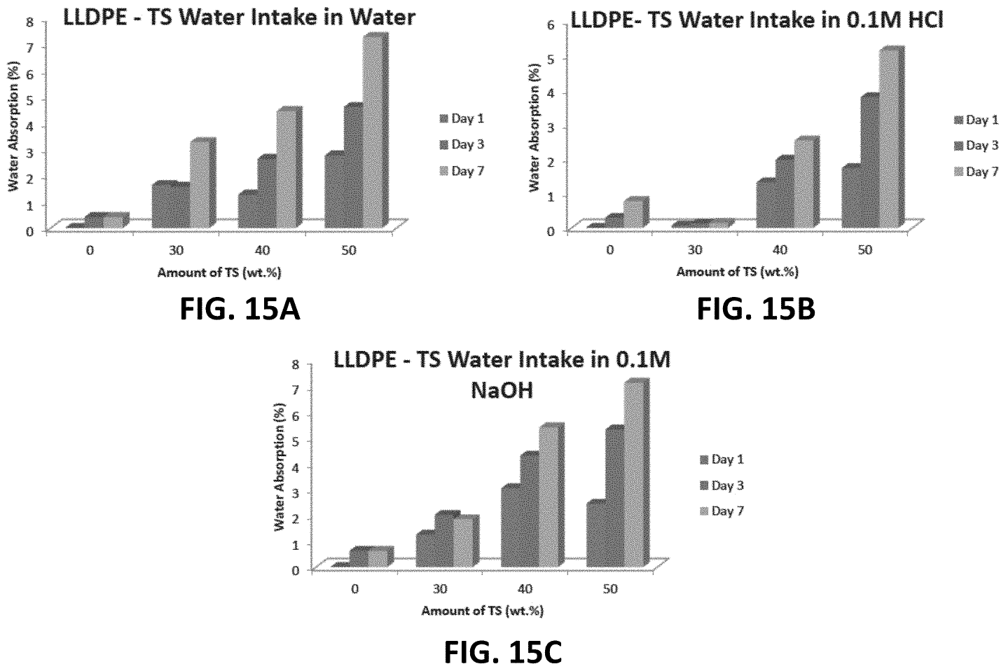

Water intake of LLDPE-TS (as produced) composites under different conditions are shown in FIGS. 15A-15C. Liquid intake of composites increased from day 1 to day 7 with increasing amount of TS fillers. Composites absorbed less water in 0.1 M HCl solution.

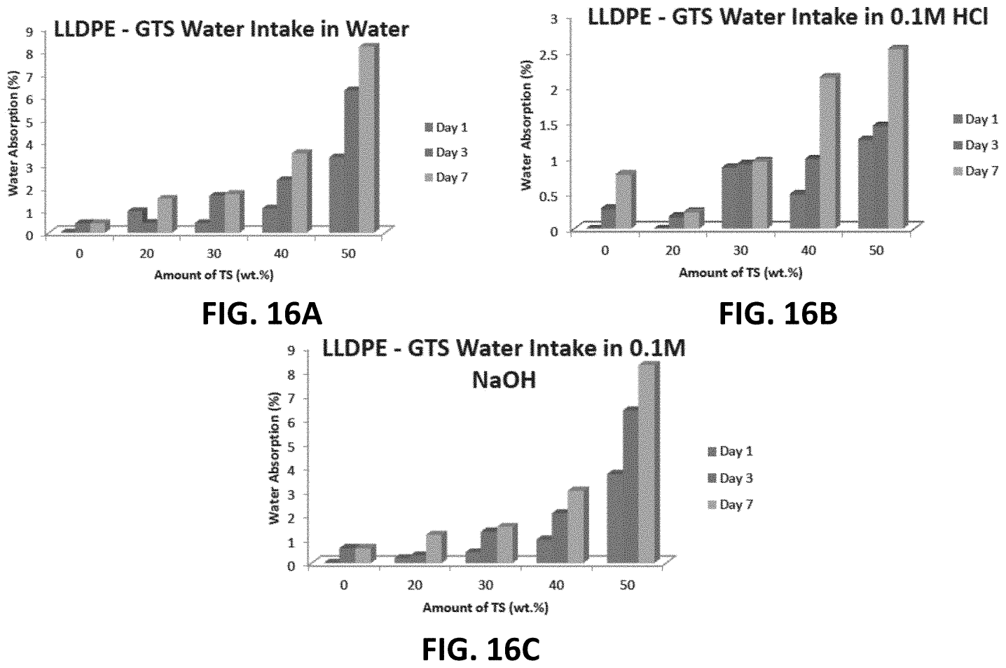

Water intake of LLDPE-ground TS composites under different conditions are shown in FIGS. 16A-16C. Liquid intake of composites slightly increased from day 1 to day 7 with an increasing amount of GTS up to 30 wt. % LLDPE/GTS and increased more significantly beyond that GTS filler amount. Composites absorbed less liquid when in 0.1 M HCl solution.

When the LLDPE/TS (as produced) composites and LLDPE/GTS (ground) composites are compared, it can be seen that, in general, LLDPE/GTS absorbed less water than LLDPE/TS, except with the 50 wt. % TS composites. This can be explained by the nature of as-produced TS which has a porous structure. In the case of as-produced particles, composites absorb the liquid in and through these pores. When the TS is ground, those pores are eliminated leading to lower liquid intake.

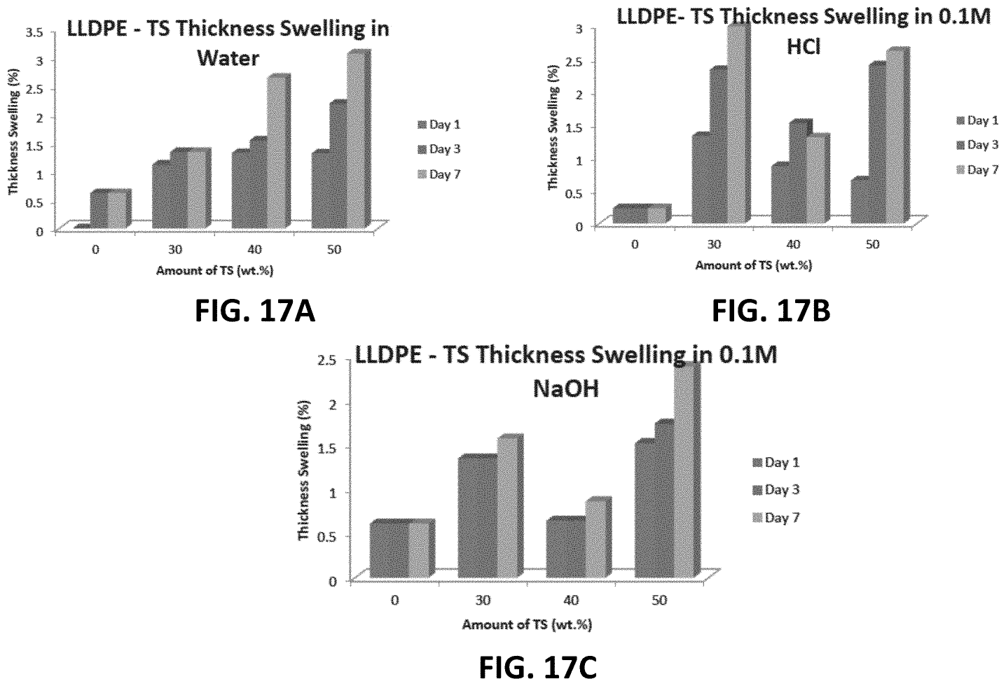

Thickness swelling of LLDPE-TS (as produced) compounds under different conditions are shown in FIGS. 17A-17C. Thickness swelling of composites increased with increasing amount of TS except for 40 wt. % TS composites which showed less thickness swelling in HCl and NaOH solutions. Such swelling is less in NaOH solution.

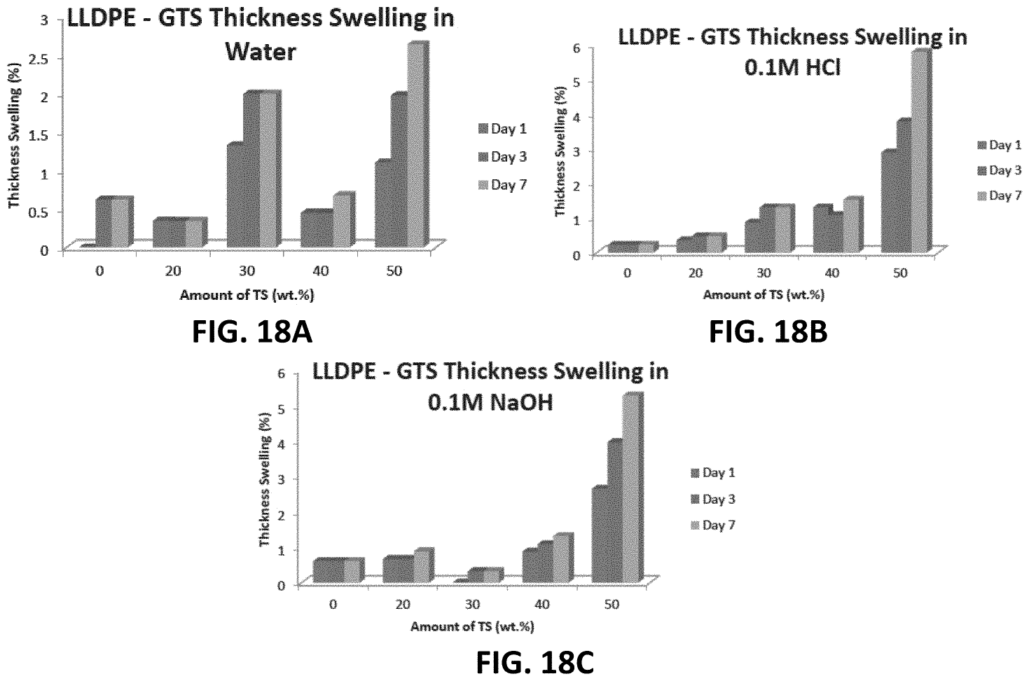

Thickness swelling of LLDPE-ground TS compounds under different conditions are shown in FIGS. 18A-28C. Thickness swelling of composites increased slightly or didn't change considerably with increasing amount of ground GTS until 50 wt. % GTS addition, except that 30 wt. % TS added composites showed more thickness swelling in water. Such swelling was less in NaOH and HCl solutions until 50 wt. % GTS addition, while the LLDPE/50 wt. % GTS composite had less swelling in water.

### Example 8. Scanning Electron Microscopy (SEM)

The fracture surfaces of samples were observed after the tensile test by using scanning electron microscopy (SEM, Hitachi S-2150 (Kumagaya, Japan). Thin layer of conducting silver was coated on to samples by using an Emitech (Kent, UK) Model-K575x Turbo Sputter Coater before the SEM analyses. Examination was performed at different magnifications to show the roughness and morphology of fracture surfaces to explain the effect of heat-treated biomass sorghum amount on polymer/TS composite structures, focusing on TS particles to observe the compatibility of TS and polymer.

Elastic modulus of PP increased with an increasing TS amount for both as produced and ground PP/TS specimens. No significant difference has been observed between as produced and ground TS-filler specimens. On the other hand, maximum stress and strain at maximum stress decreased with increasing amount of TS filler. Decrease in elongation can be attributed to local deformation process which prevents the necking of composites with an increasing filler amount, and the decrease in maximum stress can be attributed to increasing brittleness of the TS/PP composite. The PP/TS composite showed slightly lower values than PP/GTS composite at higher filler loadings due to increasing interfacial strength when using nanometer size (ground) fillers.

Elastic modulus and maximum stress values for LLDPE increased with increasing amount of TS filler for both as produced and ground LLDPE/TS specimens. Strain at maximum stress decreased with increasing amount of TS filler. Decrease in elongation can be attributed to local deformation process which prevents the necking of composites with increasing amount of filler. On the other hand, high deformation capacity of LLDPE (in comparison to PP) prevents onset of brittleness with TS addition, which allows increases in maximum stress values for the LLDPE/TS composite with increasing amounts of TS filler addition.

When the trends of the elastic moduli for PP/TS and LLDPE/TS composites were compared, the effect of TS amount was found to be similar on both composites, resulting in increasing behavior for the elastic moduli in similar proportions. In the case of strain values at maximum stress, TS addition affected LLDPE more than PP with higher amounts of strain reduction. The maximum stress values presented opposite behaviors with those for LLDPE increasing while those for PP decreasing. At the highest TS amount added (50% wt.) the maximum stress and the corresponding strain values for both LLDPE/TS and PP/TS composites became very close.

Heat Distortion Temperature (HDT) of PP/TS and humidified PP/TS composites increased with an increasing amount of TS. When compared with neat PP, up to 31.72° C. and 30.92° C. increases were obtained for heat distortion temperatures of PP/TS and humidified PP/TS composites, respectively, with TS filler addition of up to 50 wt. %. Humidifying the samples did not result in considerable changes in heat distortion temperatures. In the case of PP/ground-TS and humidified PP/ground-TS specimens; HDT increment stood at 23.53° C. and 20.97° C., respectively for the highest amount of TS addition, which indicates that the efficacy of larger (as produced) TS particles is better in increasing the heat distortion temperature for the composite in comparison to the use of smaller (ground) TS particles. HDT of LLDPE/TS increased with an increasing amount of TS resulting in 25.57° C. enhancement. Humidification did not result in considerable changes until 50% TS filler addition, which provided 19.59° C. increase. LLDPE/GTS and humidified LLDPE/GTS composites had lower gains in HDT with increases of 14.15° C. and 14.73° C. increments, at most, respectively.

Differences obtained in HDT between as produced and ground filler added composites (PP/TS-PP/GTS composites, as well as LLDPE/TS-LLDPE/GTS composites, respectively) can be attributed to reductions in freedom of movement of polymer chains which is reduced more when porous and bigger particles were added (confinement effect) in comparison to the addition of smaller (ground) particles.

There is no appreciable change in melting temperature for the PP/TS composites with TS filler addition up to 50 wt. %. The enthalpic endotherm, ΔH, however is reduced by as much as 50.65% in comparison to the neat polymer (PP) when 50 wt. % TS is added in ground form. This result points to reduction in the degree of crystallinity for the PP matrix with TS and GTS filler addition.

There is no appreciable change in melting temperature for the LLDPE/TS composites with TS filler addition up to 50 wt. %. The enthalpic endotherm, ΔH, however is reduced by as much as 49.81% in comparison to the neat polymer (PP) when 50 wt. % TS is added in ground form. This result points to reduction in the degree of crystallinity for the LLDPE matrix with TS and GTS filler addition. TGA curves of carbon black (CB) and TS were compared to approximately identify the carbon formation percentage after the heat treatment process of biomass sorghum. The TGA curve for CB reveals that the main CB oxidation reaction begins around 645.30° C. The TGA curve for TS, on the other hand, reveals that, prior to the heat treatment process, the first organic parts: moisture, relatively small, carbonized particles and some organics disintegrate and exhibit a broad peak. The carbonizing parts begin to react at 676.80° C. (close to the CB reaction temperature) due to heat treatment. Until the initiation of this TS reaction only 21.52 wt. % of TS has been burned, which indicates that the carbon conversion of biomass sorghum is approximately 78.42%.

Thermal stability of PP/TS and PP/GTS composites are higher than the neat PP material, and the stability increases with increasing amount of TS filler. The residual weight of PP/TS is slightly less than that for PP/GTS.

Thermal stability of LLDPE/TS and LLDPE/GTS composites are higher than the neat LLDPE material, and the stability increases with increasing amount of TS filler. The residual weight of LLDPE/TS is around 3% less than that for LLDPE/GTS.

Liquid intake of PP-TS (as produced) composites increased with increasing amount of TS filler from day 1 to day 7. Composites absorb more liquid in 0.1 M NaOH solution.

For the PP-Ground TS samples, Neat PP shows higher absorption in HCl solution in comparison to GTS filler addition of up to 40 wt. %. In general liquid intake of PP/GTS composites increased from day 1 to day 7 except the neat PP and PP/10% TS composites in water. Up to 30 wt. % GTS amount, liquid absorption of composites decreased or did not change considerably, and this can be explained by prevention of water intake in composites via ground TS particles. After 30 wt. % GTS, liquid intake rate increased, while such intake was minimum from the HCl solution.

Thickness swelling in PP-TS (as produced) composites increased from day 1 to day 7 with increasing amount of TS fillers. Such swelling is less in water and HCl solution than in NaOH solution.

Thickness swelling of PP-Ground TS composites increased with increasing amount of GTS fillers in general except for PP/10 wt. % GTS in HCl and NaOH solutions. Such swelling is less in water and NaOH solution than in HCl solution.

Liquid intake of LLDPE-TS (as produced) composites increased from day 1 to day 7 with increasing amount of TS fillers. Composites absorbed less water in 0.1 M HCl solution.

Liquid intake of LLDPE-Ground TS composites slightly increased from day 1 to day 7 with an increasing amount of GTS up to 30 wt. % LLDPE/GTS and increased more significantly beyond that TS filler amount. Composites absorbed less liquid when in 0.1 M HCl solution.

Thickness swelling of LLDPE-TS (as produced) composites increased with increasing amount of TS except for 40 wt. % TS composites which showed less thickness swelling in HCl and NaOH solutions. Such swelling is less in NaOH solution.

Thickness swelling of LLDPE-Ground TS composites increased slightly or didn't change considerably with increasing amount of ground GTS until 50 wt. % GTS addition, except that 30 wt. % TS added composites showed more thickness swelling in water. Such swelling was less in NaOH and HCl solutions until 50 wt. % GTS addition, while the LLDPE/50 wt. % GTS composite had less swelling in water.

Scanning Electron Microscopy (SEM) was performed at different magnifications to show the roughness and morphology of fracture surfaces to explain the effect of TS amount on polymer/TS composite structures, focusing on TS particles to observe the compatibility of TS and polymer.

The embodiments above are intended to be illustrative and not limiting. Additional embodiments are within the claims. In addition, although the present disclosure has been described with reference to particular embodiments, those skilled in the art will recognize that changes can be made in form and detail without departing from the spirit and scope of the disclosure. Any incorporation by reference of documents above is limited such that no subject matter is incorporated that is contrary to the explicit disclosure herein.

The methods and compositions described herein provide a polymeric composite material containing a heat-treated biomass and recycled or reclaimed plastic. The current polymeric composite material may be modified in multiple ways and applied in various technological applications. Although the materials of construction are generally described, they may include a variety of compositions consistent with the function described herein. Such variations are not to be regarded as a departure from the spirit and scope of this disclosure, and all such modifications as would be obvious to one skilled in the art are intended to be included within the scope of the following claims.

Throughout this application, various publications are referenced. The disclosures of these publications in their entireties are hereby incorporated by reference into this application in order to more fully describe the state of the art to which this pertains.

The references disclosed are also individually and specifically incorporated by reference herein for the material contained in them that is discussed in the sentence in which the reference is relied upon.

In some embodiment, the polymeric composite disclosed herein comprises (or consists essentially of or consists of) (a) recycled or reclaimed plastic and (b) heat-treated biomass, wherein said recycled or reclaimed plastic and said heat-treated biomass are compounded to create a polymeric composite. Said recycled or reclaimed plastics are selected from the group consisting of polypropylene, low-density polyethylene, high-density polyethylene, polystyrene, and mixtures thereof. Said recycled or reclaimed plastic has a number average molecular weight between about 10,000 and about 1,000,000 Daltons, for example between about 30,000 to about 100,000 Daltons. Said recycled or reclaimed plastic has a melt flow index between about 2 and about 10 g/10 min at 230° C., for example between about 4 and about 8 g/10 min at 230° C. Said recycled or reclaimed plastic comprises from about 50 to about 90 percent of the total weight of said polymeric composite, for example from about 60 to about 80 percent of the total weight of said polymeric composite. Said polymeric composite is comprised of (a) recycled plastics and (b) heat-treated biomass or (a) reclaimed plastics and (b) heat-treated biomass. In one embodiment, said heat-treated biomass is heat-treated agricultural feedstocks selected from the group consisting of almond shells, walnut shells, pistachio shells, almond hulls, rice hulls, rice straw, wheat straw, cotton, corn stover, sorghum, yellow pine, almond, forest litter, biomass sorghum, and mixtures thereof. Said heat-treated biomass has been heat-treated between about 400° to about 500° C. under non-oxygenated conditions, for example between about 400° to about 450° C. under non-oxygenated conditions. In one embodiment, said heat-treated biomass has been heat-treated at about 4000° under non-oxygenated conditions. Said heat-treated biomass has been heat-treated between about 30 to about 180 minutes under non-oxygenated conditions, for example between about 30 to about 120 minutes under non-oxygenated conditions or between about 30 to about 60 minutes under non-oxygenated conditions. Said heat-treated biomass degrades between about 300° and about 400° C., for example, between from about 300° to about 375° C. Said heat-treated biomass has a particle size between about 1 to about 1000 microns, for example, between about 50 to about 200 microns. Said heat-treated biomass comprises from about 5 to about 40 percent of the total weight of said polymeric composite, for example from about 10 to about 30 percent of the total weight of said polymeric composite. Said polymeric composite is prepared by a process comprising melt-blending said recycled or reclaimed plastic with said heat-treated biomass via extrusion. Said polymeric composite has a higher heat deflection temperature than a polymeric composite comprising recycled or reclaimed plastic but no heat-treated biomass. Said polymeric composite has a higher yield strength than a polymeric composite comprising recycled or reclaimed plastic but no heat-treated biomass. Said polymeric composite has a higher flexural modulus than a polymeric composite comprising recycled or reclaimed plastic but no heat-treated biomass. Said polymeric composite does not contain a compatibilizer. Said polymeric composite does not contain any of the following: glass fibers, calcium carbonate, and elastomers (e.g., natural rubber), talc powder, carbon black, talc, titanium dioxide, petroleum-based industrial compatibilizers.

The term “consisting essentially of” excludes additional method (or process) steps or composition components that substantially interfere with the intended activity of the method (or process) or composition and can be readily determined by those skilled in the art (for example, from a consideration of this specification or practice of the present disclosure disclosed herein).

The present disclosure illustratively disclosed herein suitably may be practiced in the absence of any element (e.g., method (or process) steps or composition components) which is not specifically disclosed herein. Thus, the specification includes disclosure by silence (“Negative Limitations in Patent Claims,” AIPLA Quarterly Journal, Tom Brody, 41(1): 46-47 (2013):

. . . Written support for a negative limitation may also be argued through the absence of the excluded element in the specification, known as disclosure by silence . . .

Silence in the specification may be used to establish written description support for a negative limitation. As an example, in Ex parte Lin [No. 2009-0486, at 2, 6 (B.P.A.I. May 7, 2009)] the negative limitation was added by amendment . . . In other words, the inventor argued an example that passively complied with the requirements of the negative limitation . . . was sufficient to provide support . . .

This case shows that written description support for a negative limitation can be found by one or more disclosures of an embodiment that obeys what is required by the negative limitation.

Other embodiments of the present disclosure will be apparent to those skilled in the art from a consideration of this specification or practice of the present disclosure disclosed herein. It is intended that the specification and examples be considered as exemplary only, with the true scope and spirit of the present disclosure being indicated by the following claims.

What is claimed is:

1. A heat-treated biomass, comprising an agricultural feedstock heat treated between about 400° to about 500° C. for between about 30 to about 180 minutes under non-oxygenated conditions,
wherein said agricultural feedstock is selected from the group consisting of biomass sorghum, wood, nut sells, soybean hulls, and a combination thereof, and
wherein at least about 15% of the carbon of the agricultural feedstock is consumed during the heat treatment process, leaving at least about 85% of the carbon of the agricultural feedstock in the heated treated biomass,
wherein said heat-treated biomass has been heat treated between about 30 to about 120 minutes under non-oxygenated conditions, and
wherein said heat-treated biomass has been heat treated between about 450° to about 500oC under non-oxygenated conditions.

2. The biomass of claim 1, wherein said heat-treated biomass has been heat treated at about 450° C. under non-oxygenated conditions.

3. The biomass of claim 1, wherein said heat-treated biomass has been heat treated between about 30 to about 60 minutes under non-oxygenated conditions.

4. A method of making a heat-treated biomass, the method comprising, heat treating an agricultural feedstock between about 400° to about 500° C. for between about 30 to about 180 minutes under non-oxygenated conditions,
wherein said agricultural feedstocks are selected from the group consisting of biomass sorghum, wood, nut sells, soybean hulls, and a combination thereof, and
wherein at least about 15% of the carbon of the agricultural feedstock is consumed during the heat treatment process, leaving at least about 85% of the carbon of the agricultural feedstock in the heated treated biomass.

5. The method of claim 4, wherein said heat treatment is conducted at about 450° C. under non-oxygenated conditions.

6. The method of claim 4, further comprising grinding said heat-treated biomass to a particle size between about 1 to about 1000 microns.

7. The method of claim 4, further comprising grinding said heat-treated biomass to a particle size between about 50 to about 200 microns.

8. A method of using a heat-treated biomass, wherein the heat-treated biomass having a particle size between about 1 to about 1000 microns,
the method comprising, compounding a mixture that comprises a plastic with said heat-treated biomass to form a polymeric composite,
wherein said heat-treated biomass comprises from about 5 to about 40 percent of the total weight of said polymeric composite,
wherein the heat-treated biomass is produced from an agricultural feedstock and at least about 15% of the carbon of the agricultural feedstock is consumed during a heat treatment process, leaving at least about 85% of the carbon of the agricultural feedstock in the heated treated biomass, and
wherein said plastic has a number average molecular weight between about 10,000 and about 1,000,000 Daltons.

9. The method of claim 8, wherein said plastic is selected from the group consisting of polypropylene, low-density polyethylene, high-density polyethylene, polystyrene, and mixtures thereof.

10. The method of claim 8, wherein said plastic has a melt flow index between about 2 and about 10 g/10 min at 230° C.

11. The method of claim 8, wherein said plastic comprises from about 50 to about 90 percent of the total weight of said polymeric composite.

12. The method of claim 8, wherein said plastic comprises from about 60 to about 80 percent of the total weight of said polymeric composite.

13. The method of claim 8, wherein said compounding comprising melt-blending the plastic with said heat-treated biomass via extrusion to form the polymeric composite.

14. A polymeric composite made by the method of claim 8, having a higher heat deflection temperature than a comparison polymeric composite made from the same method using the same mixture but no heat-treated biomass.

15. The polymeric composite of claim 14, having a higher yield strength than a comparison polymeric composite made from the same method using the same mixture but no heat-treated biomass.

16. The polymeric composite of claim 14, having a higher flexural modulus than a comparison polymeric composite made from the same method using the same mixture but no heat-treated biomass.

17. The polymeric composite of claim 14, wherein the plastic is a recycled plastic.

18. The polymeric composite of claim 14, wherein the plastic is a reclaimed plastic.
